(19) United States
(12) Patent Application Publication
(10) Pub. No.: US 2017/0058904 A1
(43) Pub. Date: Mar. 2, 2017

(54) FLUID DRIVING DEVICE, MOTOR ASSEMBLY AND CENTRIFUGAL FRICTION CLUTCH THEREOF

(71) Applicant: Johnson Electric S.A., Murten (CH)

(72) Inventors: Yue LI, Hong Kong (CN); Li Sheng LIU, Shen Zhen (CN); Yong WANG, Shen Zhen (CN); Ya Ming ZHANG, Shen Zhen (CN)

(21) Appl. No.: 15/255,837

(22) Filed: Sep. 2, 2016

(30) Foreign Application Priority Data
Sep. 2, 2015 (CN) 201510556394.3

(51) Int. Cl. F04D 25/06; F04D 29/28; H02K 7/108; F16D 43/18

(52) U.S. Cl. CPC F04D 25/06; F16D 43/18; F04D 29/282; H02K 7/108

(57) ABSTRACT

A centrifugal friction clutch includes a centrifugal part comprising a sleeve ring with centrifugal plates disposed thereon. A connecting member is attached around the centrifugal part. When the centrifugal part rotates with the rotary shaft, free ends of the centrifugal plates flare radially outwardly and abut against the connecting member, to cause the connecting member to rotate by a frictional force raised between the centrifugal part and the connecting member.

### CROSS REFERENCE TO RELATED APPLICATIONS

This non-provisional patent application claims priority under 35 U.S.C. §119(a) from Patent Application No. 201510556394.3 filed in The People's Republic of China on 2 Sep. 2015.

### FIELD OF THE INVENTION

This invention relates to the field of fluid driving device, and in particular to a motor assembly of a fluid driving device, and a centrifugal friction clutch of the motor assembly.

### BACKGROUND OF THE INVENTION

In a fluid driving device, such as a blower, a motor connects with an impeller to drive the impeller to rotation during operation. At startup of a single phase motor, the startup torque of the motor is small and fluctuates greatly. However, the impeller is stationary at its initial state, which requires the motor to withstand a large rotational inertia and startup load torque. As a result, vibrations may occur during startup of the motor; or even worse, motor startup failure may occur.

In a typical method of starting the single phase motor, a friction startup device is used to firstly drive the motor to rotate, which in turn progressively drives the impeller to rotate. Currently, the friction startup device consists of arcuate plates and an annular spring. Multiple arcuate plates are disposed on the impeller and are located on the same circle. The annular spring surrounds outer sides of the multiple arcuate plates. An end portion of a rotary shaft of the motor extends into a hole cooperatively defined by the multiple arcuate plates. As the rotary shaft of the motor rotates, the annular spring applies a constraint force to the multiple arcuate plates so that a friction force is generated between the arcuate plates and the rotary shaft. However, the friction force generated in this construction changes little with the the increase of the rotational speed, which is adverse to adjusting of the rotational inertia and the startup load torque and hence cannot effectively address vibrations, noises and startup failure during the motor startup.

Therefore, it is urgently desired to reduce the rotational inertia and startup load applied to the rotary shaft and reduce the vibrations, noises and startup failure during the motor startup.

### SUMMARY OF THE INVENTION

Thus, there is a desire for a centrifugal friction clutch for reducing the rotational inertia and startup load torque applied to the rotary shaft and reducing the vibrations and noises and avoiding startup failure during the motor startup. There is also a desire for a motor assembly and a blower employing the above centrifugal friction clutch.

In one aspect, a centrifugal friction clutch is provided which includes: a centrifugal part comprising a sleeve ring to be fixed on the rotary shaft and a plurality of centrifugal plates extending from the sleeve ring, distal ends of the centrifugal plates being free ends; and a connecting member for connecting to a load attached around an outer side of the centrifugal part. When the centrifugal part rotates along with the rotary shaft, the free ends of the centrifugal plates flare radially outwardly and abut against the connecting member, to cause the connecting member to rotate by a frictional force raised between the centrifugal part and the connecting member.

Preferably, the centrifugal friction clutch further comprises a positioning member for axially positioning the connecting member.

Preferably, the positioning member comprises a positioning shaft sleeve to be fixed on the rotary shaft and a first stop plate fixedly connected with the positioning shaft sleeve.

Preferably, the positioning member further comprises a second stop plate disposed at one end of the connecting member away from the first stop plate and to be fixed on the rotary shaft.

Preferably, the positioning member further comprises a positioning ring fixed connected with the second stop plate, and an outer surface of the positioning ring contacts the inner surface of the centrifugal plate.

Preferably, the second stop plate and the positioning ring are integrally formed.

Preferably, the centrifugal part is fixedly disposed on the positioning shaft sleeve.

Preferably, the positioning shaft sleeve and the first stop plate are integrally formed.

Preferably, an inner hole of the connecting member is a stepped hole, the centrifugal part is disposed in a large-diameter hole of the stepped hole, and a step end face of the stepped hole contacts and positions an end face of the centrifugal part away from the first stop plate.

Preferably, a positioning pressing block is disposed inside the centrifugal plates of the centrifugal part, one end face of the positioning pressing block contacts the step end face of the stepped hole, and the other end face of the positioning pressing block contacts an end face of the sleeve ring that connects the centrifugal plates.

Preferably, the centrifugal plates are evenly arranged on the sleeve ring.

Preferably, a groove is formed at a joint between the centrifugal plate and the sleeve ring.

The present invention further provides a motor assembly comprising a single phase motor. The motor assembly further comprises a centrifugal friction clutch as described above.

The present invention further provides a fluid driving device comprising an impeller and a motor assembly described above. Preferably, the fluid driving device is a blower.

Preferably, the motor assembly further comprises a position-limiting member disposed on the rotary shaft of the motor to limit axial movement of the impeller, and the position-limiting member is disposed at one side of the centrifugal friction clutch opposite from the motor.

Preferably, the fluid driving device is a blower.

### BRIEF DESCRIPTION OF THE DRAWINGS

In order to more clearly describe the technical solutions in the prior art or the embodiments of the present invention, the accompanying drawings to be used in the descriptions of the prior art or the embodiments are briefly introduced as follows. Obviously, the following accompanying drawings just illustrate some embodiments of the present invention, and people skilled in the art can obtain other drawings from these drawings without paying creative efforts.

FIG. 1 illustrates a first implementation of a motor assembly according to one embodiment of the present invention.

FIG. 2 is a sectional view of the first implementation of the motor assembly according to the embodiment of the present invention.

FIG. 3 is an assembled view of a second stop plate and a centrifugal part of the embodiment of the present invention.

FIG. 4 illustrates the centrifugal part of the embodiment of the present invention.

FIG. 5 illustrates a blower according to one embodiment of the present invention.

FIG. 6 illustrates a second implementation of a motor assembly according to one embodiment of the present invention.

### DETAILED DESCRIPTION OF THE PREFERRED EMBODIMENTS

The present invention discloses a centrifugal friction clutch which reduces the rotational inertia and startup load applied to the rotary shaft, reduces the vibrational noises and avoids the damage caused by motor startup failure. The present invention further discloses a motor assembly and a blower employing the above centrifugal friction clutch.

The technical solutions of the embodiments of the present invention will be clearly and completely described as follows with reference to the accompanying drawings. Apparently, the embodiments as described below are merely part of, rather than all, embodiments of the present invention. Based on the embodiments of the present disclosure, any other embodiment obtained by a person skilled in the art without paying any creative effort shall fall within the protection scope of the present invention.

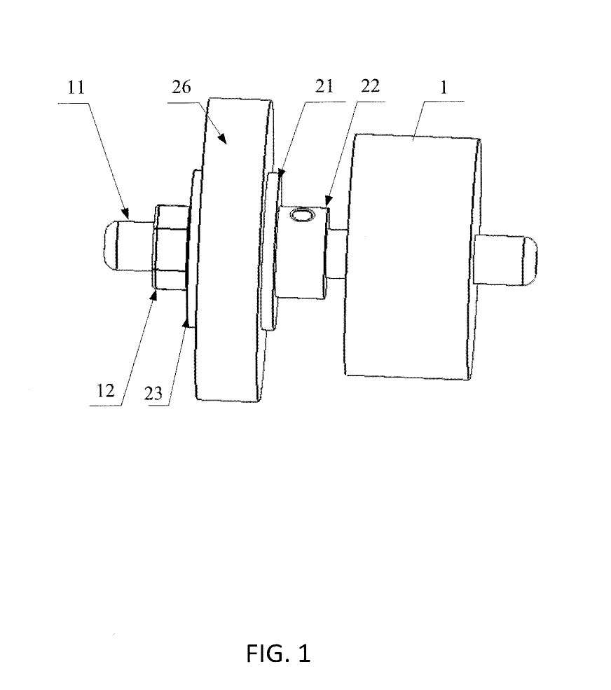

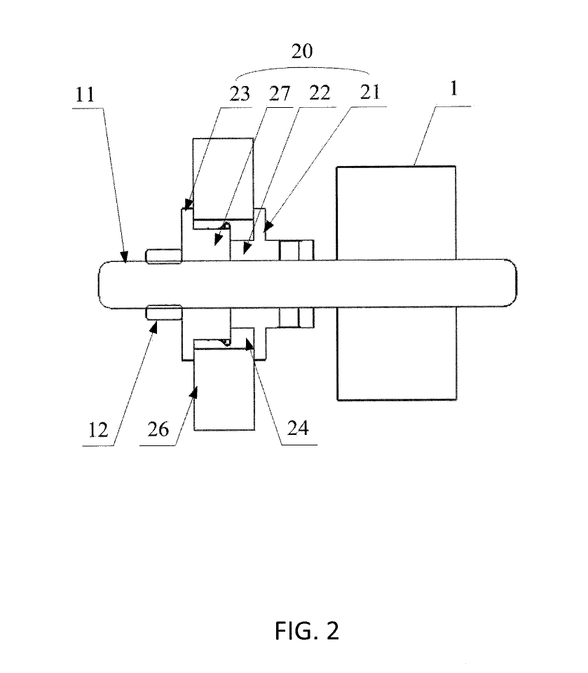

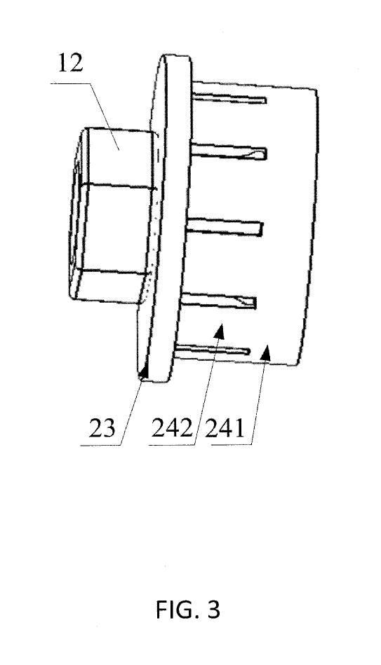

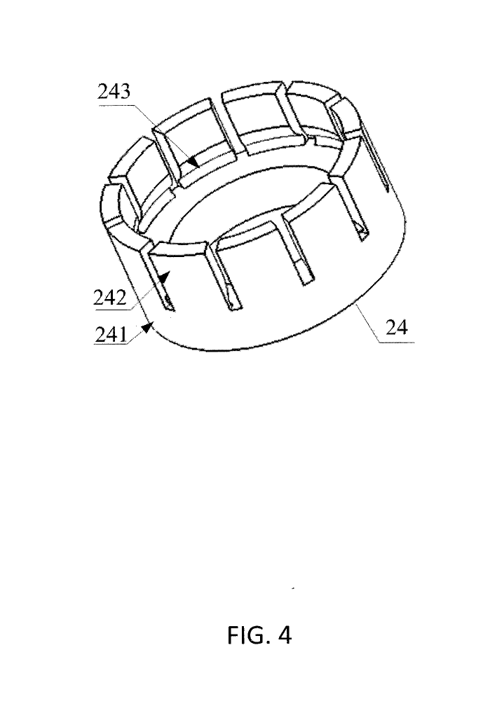

FIG. 1 illustrates a first implementation of a motor assembly according to one embodiment of the present invention. FIG. 2 is a sectional view of the first implementation of the motor assembly according to one embodiment of the present invention. FIG. 3 is an assembled view of a second stop plate and a centrifugal part of one embodiment of the present invention. FIG. 4 illustrates the centrifugal part of one embodiment of the present invention.

A centrifugal friction clutch in accordance with one embodiment of the present invention includes a centrifugal part 24 and a loading wheel 26. The centrifugal part 24 includes a sleeve ring 241 and a centrifugal plate 242. The sleeve ring 241 is configured to be fixed to the rotary shaft 11. The centrifugal plate 242 is disposed on the sleeve ring 241. A distal end of the centrifugal plate 242 is a free end. As the rotary shaft 11 rotates, the centrifugal part 24 rotates along with the rotary shaft 11. The centrifugal plate 242 tilts in a direction away from an axis of the sleeve ring 241 under a centrifugal force. The loading wheel 26 is attached around an outer side of the centrifugal part 24. That is, the loading wheel 26 has an inner hole in which the centrifugal part 24 is received. When the centrifugal part 24 rotates with the rotary shaft 11, the free end of the centrifugal plate 242 flares radially outwardly to abut against an inner wall of the loading wheel 26 and, as a result, the loading wheel 26 is driven to rotate by a frictional force.

In the centrifugal friction clutch of the embodiment of the present invention, at startup of the motor 1, the centrifugal part 24 rotates along with the rotary shaft 11. When the rotational speed of the rotary shaft 11 is low, the free end of the centrifugal plate 242 flares radially outwardly to a small extent because the centrifugal plate 242 is subject to a small centrifugal force, such that a frictional force between the centrifugal plate 242 and the loading wheel 26 is small or even zero, and the centrifugal part 24 slides relative to the loading wheel 26. As the rotational speed of the rotary shaft 11 increases, the centrifugal force applied to the centrifugal plate 242 increases, and the free end of the centrifugal plate 242 tilts in the direction away from the axis of the sleeve ring 241. The centrifugal part 24 is received in the inner hole of the loading wheel 26, and the tilted centrifugal plate 242 contacts a wall of the inner hole, such that the frictional force between the centrifugal part 24 and the loading wheel 26 increases accordingly. When the frictional is large enough, the centrifugal part 24 drives the loading wheel 26 to rotate synchronously.

By means of the above configuration, the frictional force between the centrifugal part 24 and the loading wheel 26 is small or no frictional force exists therebetween at startup of the motor 1 when the rotational speed of the rotary shaft 11 is low. Because the loading wheel 26 and the impeller 3 are directly or indirectly connected, the impeller 3 is stationary at the startup of the motor 1, such that the centrifugal part 24 and the loading wheel 26 slide relative to each other to form a sliding friction pair at the startup of the motor 1. As the rotational speed of the rotary shaft 11 of the motor 1 increases, the centrifugal force applied to the centrifugal plate 242 increases, and the frictional force between the centrifugal part 24 and the loading wheel 26 also increases. The amount of relative sliding movement between the centrifugal part 24 and the loading wheel 26 decreases until the centrifugal part 24 and the loading wheel 26 become stationary relative to each other so that the motor drives the loading wheel 26 to rotate synchronously through the centrifugal friction clutch. In the centrifugal friction clutch of the embodiment of the present invention, the frictional force between the centrifugal part 24 and the loading wheel 26 is proportional to a square of the rotational speed of the rotary shaft 11. When at low speed (startup of the motor 1), the centrifugal plate 242 and the loading wheel 26 slide relative to each other, which reduces the rotational inertia and startup load torque applied to the rotary shaft 11, reduces the vibrational noises at startup of the motor 1, and avoids the startup failure of the motor 1.

It should be understood that the distal end of the centrifugal plate 242 is one end of the centrifugal plate 242 that is not connected with the sleeve ring 241. Preferably, one end of the centrifugal plate 242 is connected with one end of the sleeve ring 241, and one end of the centrifugal plate 242 away from the sleeve ring 241 is the distal end of the centrifugal plate 242. Alternatively, the centrifugal plate 242 may also be disposed on an outer surface of the sleeve ring 241.

The embodiment of the present invention further provides a positioning member 20 for axially positioning the loading wheel 26. By providing the positioning member 20, the loading wheel 26 can be axially positioned, which avoids wobble of the loading wheel 26.

Referring to FIG. 1 and FIG. 2, in a first embodiment, the positioning member 20 includes a positioning shaft sleeve 22 fixed on the rotary shaft 11 and a first stop plate 21 fixedly connected with the positioning shaft sleeve 22. By means of the above configuration, the first stop plate 21 and the positioning shaft sleeve 22 achieve the axial positioning to the loading wheel 26 and facilitate mounting of the positioning member. In assembly of the loading wheel 26 to the rotary shaft 11, an end face of one side of the loading wheel 26 toward an assembling direction contacts the first stop plate 21.

In this embodiment, the inner hole of the loading wheel 26 is a circular cylindrical hole. In order to prevent the loading wheel 26 from moving in a direction opposite to the assembling direction, the positioning member 20 further includes a second stop plate 23 for being fixed on the rotary shaft 11. The second stop plate 23 is disposed at one end of the loading wheel 26 away from the first stop plate 21. The first stop plate 21 is disposed at one end of the loading wheel 26, and the second stop plate 23 is disposed at the other end of the loading wheel 26, such that the loading wheel 26 can be axially positioned. Preferably, an axial length of the inner hole of the loading wheel 26 is the same as an axial length of the centrifugal part 24, such that the centrifugal part 24 can be axially positioned by means of the first stop plate 21 and the second stop plate 23.

The positioning member 20 further includes a positioning ring 27 fixedly connected with the second stop plate 23. An outer surface of the positioning ring 27 contacts an inner surface of the centrifugal plate 242. The positioning ring 27 supports the centrifugal plate 242 and prevents the centrifugal plate 242 from bending toward a center of the centrifugal part 24.

Preferably, the positioning ring 27 and the second stop plate 23 are formed into an integral structure. Through this configuration, only one of the positioning ring 27 and the second stop plate 23 needs to be fixed relative to the rotary shaft 11. In addition, separate fabrication and mounting of the positioning ring 27 and the second stop plate 23 is voided, which facilitates assembly thereof.

In this embodiment, the centrifugal part 24 is fixedly disposed on the positioning shaft sleeve 22. By attaching the centrifugal part 24 around the positioning shaft sleeve 22, the axial length and hence the overall length of the centrifugal friction clutch is reduced. Alternatively, the centrifugal part 24 can also be directly fixed on the rotary shaft 11, which is not described herein in detail and falls within the scope of the present invention.

Further, the positioning shaft sleeve 22 and the first stop plate 21 are formed into an integral structure. With the positioning shaft sleeve 22 and the first stop plate 21 formed into an integral structure, only one of the positioning shaft sleeve 22 and the first stop plate 21 needs to be fixed relative to the rotary shaft. In addition, this avoids separate fabrication and mounting of the positioning shaft sleeve 22 and the first stop plate and facilitates assembly thereof.

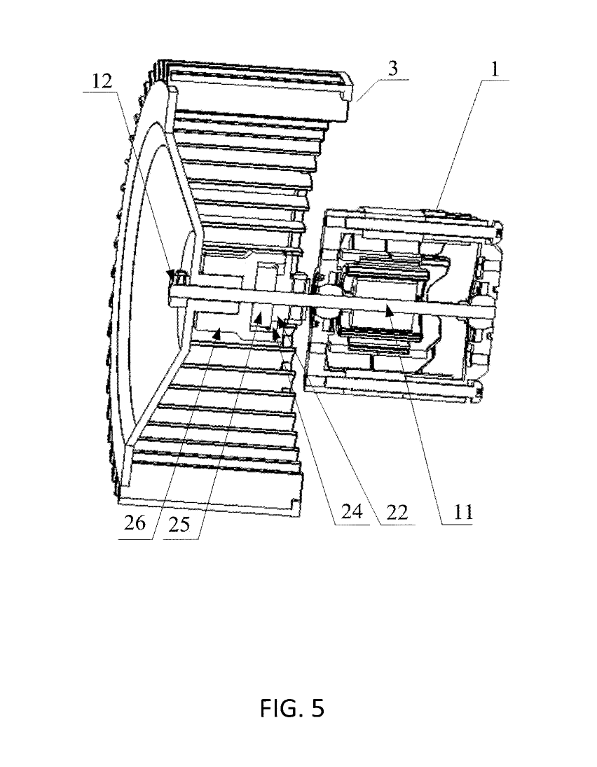

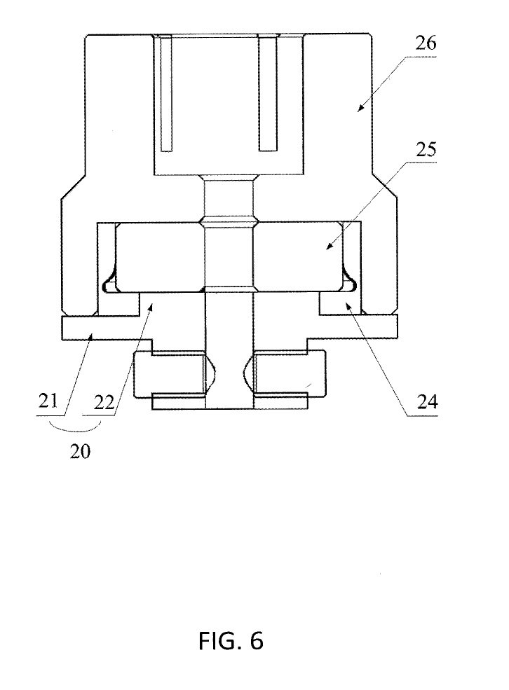

As shown in FIG. 5 and FIG. 6, in a second embodiment, the inner hole of the loading wheel 26 is a stepped hole having coaxially arranged large-diameter hole and small-diameter hole. The centrifugal part 24 is disposed within the large-diameter hole of the stepped hole. A step end face of the stepped hole contacts an end face of the centrifugal part 24 away from the first stop plate 21. The small-diameter hole allows the rotary shaft 11 to pass therethrough.

The positioning member 20 of this embodiment likewise includes the positioning shaft sleeve 22 for being fixed on the rotary shaft 11 and the first stop plate 21 fixedly connected with the positioning shaft sleeve 22.

In this embodiment, a positioning pressing block 25 is disposed inside the centrifugal plate 242 of the centrifugal part 24. One end face of the positioning pressing block 25 contacts the step end face of the stepped hole, and the other end face of the positioning pressing block 25 contacts an end face of the sleeve ring 241 that connects with the centrifugal plate 242. The positioning pressing block 25 supports the centrifugal plate 242 and prevents the centrifugal plate 242 from bending toward a center of the centrifugal part 24.

As shown in FIG. 4, an elastic groove 243 is formed at a connecting area between the centrifugal plate 242 and the sleeve ring 241. By providing the elastic groove 243, a thickness of the connecting area between the centrifugal plate 242 and the sleeve ring 241 is reduced, which more facilitates the tilting of the centrifugal plate 242 under the centrifugal force.

In this embodiment, the elastic groove 243 is located at an inner side of the connecting area between the centrifugal plate 242 and the sleeve ring 241. Alternatively, the elastic groove 243 may also be formed at an outer side of the connecting area between the centrifugal plate 242 and the sleeve ring 241.

Further, there is a plurality of the centrifugal plates 242 uniformly arranged on the sleeve ring 241. Through this configuration, the distribution of the frictional force between the centrifugal part 24 and the loading wheel 26 is made more uniform. Alternatively, at least one centrifugal plate 242 is provided.

One embodiment of the present invention further provides a motor assembly including a single phase motor 1 and a centrifugal friction clutch 2. The centrifugal friction clutch 2 is any one of the above-described centrifugal friction clutches. Since the above-described centrifugal friction clutches achieve the above-described technical results, the motor assembly employing the above-described centrifugal friction clutch can also achieve the same technical results, which are not described further herein one by one.

In order to facilitate the axial positioning of the impeller 3, the motor assembly in accordance with the embodiment of the present invention further includes a position-limiting member 12 disposed on the rotary shaft 11 of the motor 1 to limit axial movement of the impeller 3. The position-limiting member 12 is disposed at one side of the centrifugal friction clutch 2 opposite from a main body of the motor 1.

As shown in FIG. 3, the position-limiting member 12 is configured to be a nut, and an end portion of the rotary shaft 11 is provided with threads for engaging with the nut. In an alternative embodiment, the position-limiting member 12 is positioned on the rotary shaft 11 with a fastening screw 13. In still another embodiment, the position-limiting member 12 may be configured to be a clip spring, and the end portion of the rotary shaft 11 is provided with a latching groove for engaging with the clip spring. These embodiments all fall within the scope of the present invention, which are not described further herein one by one.

One embodiment of the present invention further provides a blower including an impeller 3 and a motor assembly. The motor assembly is any one of the above-described motor assemblies. Since the above-described motor assemblies achieve the above-described technical results, the blower employing the above-described motor assembly can also achieve the same technical results, which are not described further herein one by one.

All embodiments in the specification are described in a progressive way, each embodiment mainly describes the differences from other embodiments, and the same and similar parts among the embodiments can be referenced mutually.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. A centrifugal friction clutch comprising:
a centrifugal part comprising a sleeve ring to be fixed on the rotary shaft and a plurality of centrifugal plates extending from the sleeve ring, distal ends of the centrifugal plates being free ends; and
a connecting member for connecting to a load attached around an outer side of the centrifugal part, wherein when the centrifugal part rotates along with the rotary shaft, the free ends of the centrifugal plates flare radially outwardly and abut against the connecting member, to cause the connecting member to rotate by a frictional force raised between the centrifugal part and the connecting member.

2. The centrifugal friction clutch of claim 1, further comprising a positioning member for axially positioning the connecting member.

3. The centrifugal friction clutch of claim 2, wherein the positioning member comprises a positioning shaft sleeve to be fixed on the rotary shaft and a first stop plate fixedly connected with the positioning shaft sleeve.

4. The centrifugal friction clutch of claim 3, wherein the positioning member further comprises a second stop plate disposed at one end of the connecting member away from the first stop plate and to be fixed on the rotary shaft.

5. The centrifugal friction clutch of claim 4, wherein the positioning member further comprises a positioning ring fixed connected with the second stop plate, and an outer surface of the positioning ring contacts the inner surface of the centrifugal plate.

6. The centrifugal friction clutch of claim 5, wherein the second stop plate and the positioning ring are integrally formed.

7. The centrifugal friction clutch of claim 3, wherein the centrifugal part is fixedly disposed on the positioning shaft sleeve.

8. The centrifugal friction clutch of claim 3, wherein the positioning shaft sleeve and the first stop plate are integrally formed.

9. The centrifugal friction clutch of claim 3, wherein an inner hole of the connecting member is a stepped hole, the centrifugal part is disposed in a large-diameter hole of the stepped hole, and a step end face of the stepped hole contacts and positions an end face of the centrifugal part away from the first stop plate.

10. The centrifugal friction clutch of claim 9, wherein a positioning pressing block is disposed inside the centrifugal plates of the centrifugal part, one end face of the positioning pressing block contacts the step end face of the stepped hole, and the other end face of the positioning pressing block contacts an end face of the sleeve ring that connects the centrifugal plates.

11. The centrifugal friction clutch of claim 1, wherein the centrifugal plates are evenly arranged on the sleeve ring.

12. The centrifugal friction clutch of claim 1, wherein a groove is formed at a joint between the centrifugal plate and the sleeve ring.

13. A motor assembly comprising a single phase motor and a centrifugal friction clutch according to claim 1.

14. A fluid driving device comprising an impeller and a motor assembly according to claim 13.

15. The fluid driving device of claim 14, wherein the motor assembly further comprises a position-limiting member disposed on the rotary shaft of the motor to limit axial movement of the impeller, and the position-limiting member is disposed at one side of the centrifugal friction clutch opposite from the motor.

16. The fluid driving device of claim 14, wherein the fluid driving device is a blower.
